(19) United States
(12) Patent Application Publication
(10) Pub. No.: US 2024/0070339 A1
(43) Pub. Date: Feb. 29, 2024

(54) METHOD AND SYSTEM FOR REAL-TIME MULTI-DIMENSIONAL MODELLING OF TRANSMISSION TOWERS

(71) Applicant: DEGI TRANS PRIVATE LIMITED, HYDERABAD (IN)

(72) Inventors: Sri Mahesh MAGADALA, Hyderabad (IN); Kasinikota Karthik RATNA SAI, Hyderabad (IN); Kasinikota Jaswanth VENKATA SAI, Hyderabad (IN)

(21) Appl. No.: 18/452,595

(22) Filed: Aug. 21, 2023

(30) Foreign Application Priority Data
Aug. 24, 2022 (IN) 202241048313

(51) Int. Cl. G06F 30/13

(52) U.S. Cl. CPC G06F 30/13; G06F 2111/06

(57) ABSTRACT

A method and system for real-time multi-dimensional modelling of transmission towers. The system 100 includes a processing subsystem hosted on a server. The processing subsystem includes an input module to receive input data from a user. The input data includes information of a plurality of parameters and count of slopes required to model a transmission tower. Further, the processing subsystem includes a generating module to generate a parameter table, panel information table, a multi-dimensional model and a plurality of output files of the transmission tower. Furthermore, the processing subsystem includes a pattern generation module to construct one or more patterns of the multi-dimensional model. Moreover, the processing subsystem includes a display module to present the multi-dimensional model along with the one or more patterns to the user.

### CROSS-REFERENCE TO RELATED APPLICATION

This application claims priority from a patent application filed in India having Patent Application No. 202241048313, filed on Aug. 24, 2022, and titled “METHOD AND SYSTEM FOR REAL-TIME MULTI-DIMENSIONAL MODELLING OF TRANSMISSION TOWERS.”

### FIELD OF INVENTION

Embodiments of the present disclosure relate to the field of power engineering, and more particularly, a system and a method for multi-dimensional modelling of transmission towers in real-time.

### BACKGROUND

Transmission towers is a structure set up for the purpose of transmitting and receiving power, radio, telecommunication, electrical, television and other electromagnetic signals. The transmission towers support the high-voltage conductors of overhead power lines. Typically, the transmission towers are tall structures, their height being much more that their lateral dimensions. The height of the transmission towers is fixed by a user and the structural designer has the task of designing the general configuration, member, and the joint details.

A high voltage transmission line structure is a complex structure, and its design (also referred to ‘tower geometry’) is characterized by special requirements to be met from both electrical and structural points of view. The user decides the general shape of the tower in respect of its height and the length of its cross arms that carry electrical conductors. Further, the shape, height and sturdiness (mechanical strength) depend on the stresses to which they are exposed.

Typically, tower geometry is time consuming and increases with the complexity of its design. Additionally, body wind load calculations are also time consuming both in creation and modification. To achieve accurate and optimized tower design, several geometry configurations need to be analyzed thus making the designer spend additional time in geometry, body wind loads and weight calculation.

Currently, the increasing demand for electrical energy can be met by developing different configurations of transmission line towers. However, the modelling of the transmission towers remains a challenge. The manual effort for creating the complex structure is a tedious process.

Hence, there is a need for an improved system and method for a faster and easier multi-dimensional modelling of transmission towers in real-time which addresses the aforementioned issue(s).

### BRIEF DESCRIPTION

In accordance with an embodiment of the present disclosure, a system for multi-dimensional modelling of transmission towers in real-time is provided. The system includes a processing subsystem hosted on a server. The processing subsystem is configured to execute on a network to control bidirectional communications among a plurality of modules. The processing subsystem includes an input module operatively coupled with a user interface. The input module is configured to receive input data comprising of a plurality of parameters in succession and a count of a plurality of slopes required to model a transmission tower from a user. The plurality of parameters comprises information of the plurality of slopes, base width and top width of the plurality of slopes and information of a plurality of panels. Further, the processing subsystem includes a generating module operatively coupled to the input module configured to: generate a parameter table in response to the user selecting a base shape of the transmission tower, wherein the parameter table is generated by auto-calculation of values corresponding to the plurality of slopes and the plurality of parameters received from the user, generate a panel information table based on the generated parameter table and generate a multi-dimensional model of the transmission tower in real-time based on the panel information table along with a plurality of output files. Furthermore, the processing subsystem includes a pattern generation module operatively coupled to the generating module, wherein the pattern generation module is configured to construct one or more patterns of the multi-dimensional model of the transmission tower and subsequently the one or more patterns is stored in a database. Moreover, the processing subsystem includes a display module to present the multi-dimensional model of the transmission tower along with the one or more patterns to the user. The processing subsystem also includes an optimizing module operatively coupled to the generating module and configured to receive optimization parameters for the generated multi-dimensional model of the transmission tower based on one or more natural factors, wherein the natural factors comprise of wind loads and weight of the plurality of structures. The processing subsystem also includes a recommendation module operatively coupled with the pattern generation module and configured to: validate the geometry data for overloading conditions and subsequently rendering suggestions to withstand the overloading conditions by altering the geometry data and validate the geometry data for overloading conditions and subsequently rendering suggestions to withstand the overloading conditions by altering the geometry data.

In accordance with another embodiment of the present disclosure, a method for multi-dimensional modelling of transmission towers in real-time is provided. The method includes receiving input data comprising of a plurality of parameters in succession and a plurality of slopes required to model a transmission tower from a user, wherein the plurality of parameters comprises information of the plurality of slopes, base width, and top width of the plurality of slopes and information of a plurality of panels. The method also includes generating a parameter table in response to the user selecting a base shape of the transmission tower, wherein the parameter table is generated by auto-calculation of values corresponding to the plurality of slopes and the plurality of parameters received from the user. The method also includes generating a panel information table based on the generated parameter table. The method also includes generating a multi-dimensional model of the transmission tower in real-time based on the panel information table along with a plurality of output files. Further, the method includes constructing one or more patterns of the multi-dimensional model of the transmission tower. Furthermore, the method includes presenting the multi-dimensional model of the transmission tower along with the one or more patterns to the user. Moreover, the method includes validating the geometry data for overloading conditions and subsequently rendering suggestions to withstand the overloading conditions by altering the geometry data. The method also includes recommending one or more combinations of assembling the transmission tower based on geographical and climatic conditions.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for multi-dimensional modelling of transmission towers in real-time in accordance with an embodiment of the present disclosure;

FIG. 2a-FIG. 2e are exemplary models of transmission towers in accordance with an embodiment of the present disclosure;

FIG. 3 is a block diagram of a computer or a server in accordance with an embodiment of the present disclosure; and

FIG. 4 illustrates a flow chart representing the steps involved in a method for multi-dimensional modelling of transmission towers in real-time in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for multi-dimensional modelling of transmission towers in real-time. The system includes a processing subsystem hosted on a server. The processing subsystem is configured to execute on a network to control bidirectional communications among a plurality of modules The processing subsystem includes an input module operatively coupled with a user interface. The input module is configured to receive input data comprising of a plurality of parameters in succession and a count of a plurality of slopes required to model a transmission tower from a user. The plurality of parameters comprises information of the plurality of slopes, base width and top width of the plurality of slopes and information of a plurality of panels. Further, the processing subsystem includes a generating module operatively coupled to the input module configured to: generate a parameter table in response to the user selecting a base shape of the transmission tower, wherein the parameter table is generated by auto-calculation of values corresponding to the plurality of slopes and the plurality of parameters received from the user, generate a panel information table based on the generated parameter table and generate a multi-dimensional model of the transmission tower in real-time based on the panel information table along with a plurality of output files. Furthermore, the processing subsystem includes a pattern generation module operatively coupled to the generating module, wherein the pattern generation module is configured to construct one or more patterns of the multi-dimensional model of the transmission tower. Moreover, the processing subsystem includes a display module to present the multi-dimensional model of the transmission tower along with the one or more patterns to the user. The processing subsystem also includes an optimizing module operatively coupled to the generating module and configured to receive optimization parameters for the generated multi-dimensional model of the transmission tower based on one or more natural factors, wherein the natural factors comprise of wind loads and weight of the plurality of structures. The processing subsystem also includes a recommendation module operatively coupled with the pattern generation module and configured to: validate the geometry data for overloading conditions and subsequently rendering suggestions to withstand the overloading conditions by altering the geometry data and validate the geometry data for overloading conditions and subsequently rendering suggestions to withstand the overloading conditions by altering the geometry data.

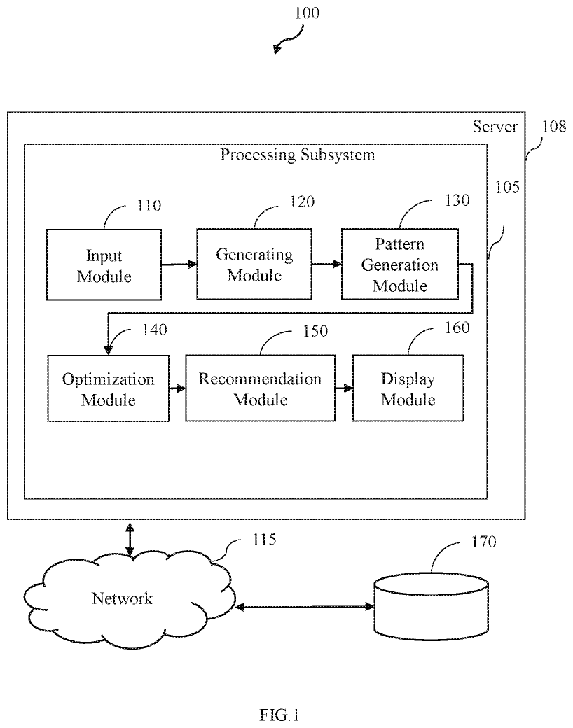

FIG. 1 is a block diagram representation of a system 100 for real-time multi-dimensional modelling of transmission towers in accordance with an embodiment of the present disclosure. The system 100 includes a processing subsystem 105 hosted on a server 108. In one embodiment, the server 108 may include a cloud-based server. In another embodiment, parts of the server 108 may be a local server coupled to a user device (not shown in FIG. 1). The processing subsystem 105 is configured to execute on a network 115 to control bidirectional communications among a plurality of modules. In one example, the network 115 may be a private or public local area network (LAN) or Wide Area Network (WAN), such as the Internet. In another embodiment, the network 115 may include both wired and wireless communications according to one or more standards and/or via one or more transport mediums. In one example, the network 115 may include wireless communications according to one of the 802.11 or Bluetooth specification sets, or another standard or proprietary wireless communication protocol. In yet another embodiment, the network 115 may also include communications over a terrestrial cellular network, including, a global system for mobile communications (GSM), code division multiple access (CDMA), and/or enhanced data for global evolution (EDGE) network.

The processing subsystem 105 is configured with a machine-readable program (herein referred as “TowGeom”) that can execute an advanced 3D graphics tool to perform the method disclosed herein. The tool generates the geometry of transmission towers in a very minimal time (for instance, ten minutes), creates body wind loads and tower weights. It is to be noted that currently the tool supports for PLS-Tower, however, should not be limited to the said.

The system 100 includes an input module 110 configured to receive input data from a user. The input data comprises a plurality of parameters in succession and a count of a plurality of slopes required to model a transmission tower. Further, the plurality of parameters comprises information of the plurality of slopes, base width and top width of the plurality of slopes and information of a plurality of panels.

In one embodiment, the plurality of parameters includes slopes, panels, members, nodes and extensions of the transmission tower in succession.

In one embodiment, the input data is validated upon receiving to detect the presence of errors and subsequently report the errors to the user.

The system 100 also includes a generating module 120 operatively coupled to the input module. The generating module is configured to generate a parameter table in response to the user selecting a base shape of the transmission tower and generate a panel information table based on the generated parameter table. The parameter table is generated by auto-calculation of values corresponding to the plurality of slopes and the plurality of parameters received from the user. The generating module is also configured to generate a multi-dimensional model of the transmission tower in real-time based on the panel information table along with a plurality of output files.

In one embodiment, the multi-dimensional model comprises a two-dimensional (2D) graphical representation and a three-dimensional (3D) graphical representation of the transmission tower. The two-dimensional graphical representation is used for reporting purposes whereas the three-dimensional graphical representation is used to display a precise interpretation of the transmission tower to the user.

In one embodiment, the output files are forwarded to a third-party application. It is to be noted that the third-party application refers to a tower designing application such as PLS-Tower.

The system 100 also includes a pattern generation module 130 operatively coupled to the generating module, wherein the pattern generation module is configured to construct one or more patterns of the multi-dimensional model of the transmission tower. In one embodiment, the one or more patterns are created with multiple combinations of extensions associated to the transmission tower.

In one embodiment, the one or more patterns of the multi-dimensional model of the transmission tower is stored in a pattern library, wherein the patten library allows the user to select a desired tower pattern for subsequent modelling process.

The system 100 also includes an optimization module 140 operatively coupled to the pattern generation module 130 and is configured to receive optimization parameters for the generated multi-dimensional model of the transmission tower based on one or more natural factors. The natural factors comprise of body wind loads and weight of the plurality of structures. In one embodiment, the optimization module 140 automatically computes the body wind area with respect to distribution to wind on levels of a transverse face and longitudinal face. Additionally, the body wind area is calculated for 0-degree wind, 30-degree wind and 45-degree wind. Specifically, the body wind area is automatically updated in response to changes in section size and redundant size which are referred from an angle database 170.

The system 100 also includes a recommendation module 150 operatively coupled to the pattern generation module 130 and is configured to validate the geometry data for tower clearances and subsequently rendering suggestions by altering the geometry data. In one embodiment, errors that are identified in the geometry data may be displayed with the aid of visual representations such as red circles. The recommendation module 150 is also configured to recommend one or more combinations of assembling the transmission tower based on geographical and climatic conditions.

The system 100 also includes a display module to present the multi-dimensional model of the transmission tower along with the one or more patterns to the user.

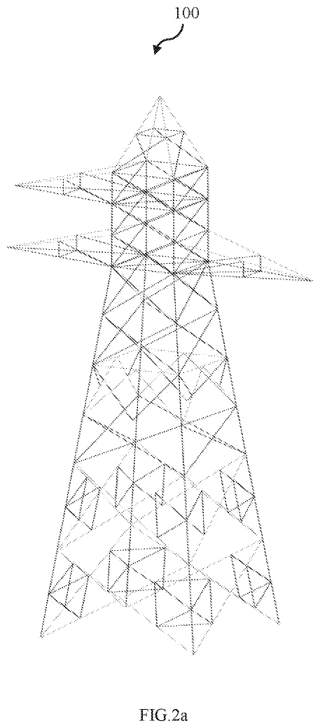

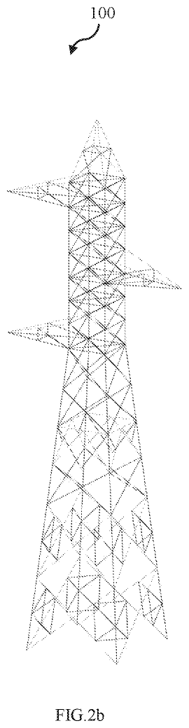

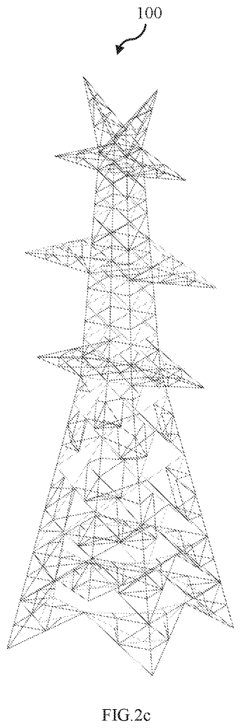

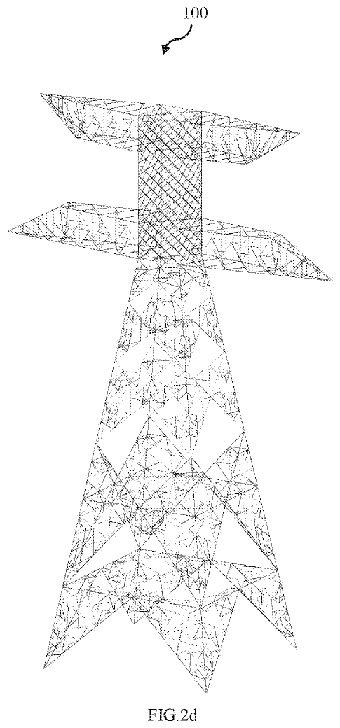

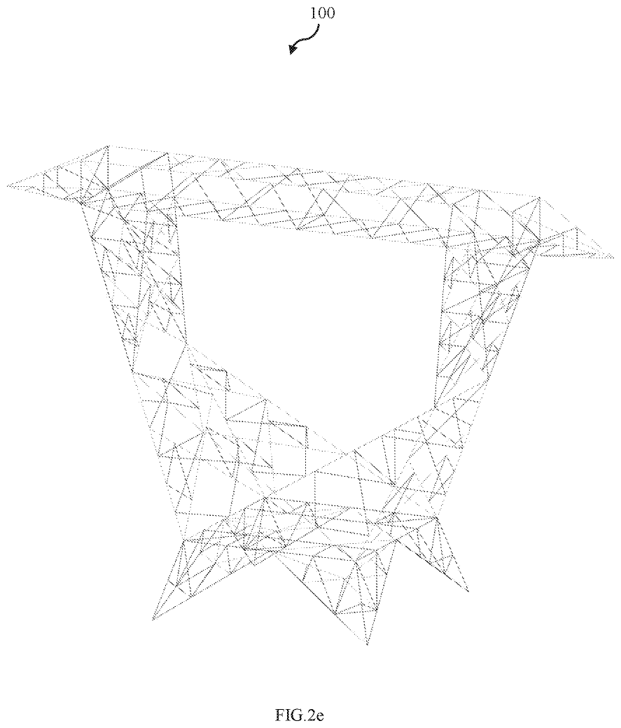

FIG. 2a-FIG. 2e are exemplary models of transmission towers in accordance with an embodiment of the present disclosure.

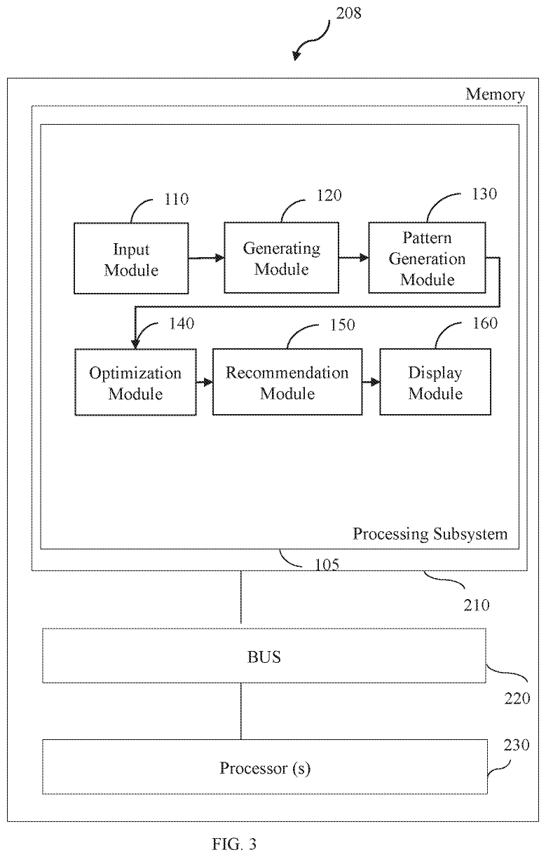

FIG. 3 is a block diagram of a computer or a server in accordance with an embodiment of the present disclosure. The server 208 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules: an input module 110, a generating module 120, a pattern generation module 130, an optimization module 140, a recommendation module 150 and a display module 160.

The input module 110 is configured to receive input data comprising of a plurality of parameters in succession and a count of a plurality of slopes required to model a transmission tower from a user. The plurality of parameters comprises information of the plurality of slopes, base width and top width of the plurality of slopes and information of a plurality of panels. Further, the generating module 120 is operatively coupled to the input module configured to: generate a parameter table in response to the user selecting a base shape of the transmission tower, wherein the parameter table is generated by auto-calculation of values corresponding to the plurality of slopes and the plurality of parameters received from the user, generate a panel information table based on the generated parameter table and generate a multi-dimensional model of the transmission tower in real-time based on the panel information table along with a plurality of output files. Furthermore, the pattern generation module 130 is operatively coupled to the generating module, wherein the pattern generation module is configured to construct one or more patterns of the multi-dimensional model of the transmission tower. In one embodiment, the one or more patterns are created with multiple combinations of extensions associated to the transmission tower. The optimizing module 140 is operatively coupled to the generating module and configured to receive optimization parameters for the generated multi-dimensional model of the transmission tower based on one or more natural factors, wherein the natural factors comprise of wind loads and weight of the plurality of structures. The recommendation module 150 is operatively coupled with the pattern generation module and configured to: validate the geometry data for tower clearances and subsequently rendering suggestions to the user by altering the geometry data and validate the geometry data and subsequently rendering suggestions to withstand the overloading conditions by altering the geometry data. Moreover, the display module 160 is configured to present the multi-dimensional model of the transmission tower along with the one or more patterns to the user.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

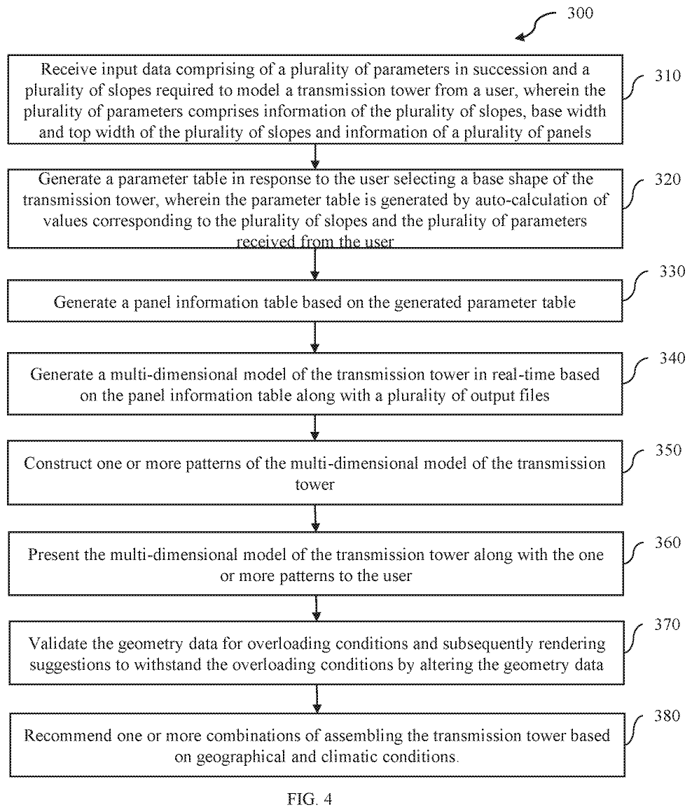

FIG. 4 illustrates a flow chart representing the steps involved in a method 300 for multi-dimensional modelling of transmission towers in real-time in accordance with an embodiment of the present disclosure.

The method 300 includes receiving input data comprising of a plurality of parameters in succession and a plurality of slopes required to model a transmission tower from a user in step 310. In one embodiment, the plurality of parameters includes information of the plurality of slopes, base width and top width of the plurality of slopes and information of a plurality of panels. In one embodiment, a text box is displayed to the user on a tab page via a user interface. The user can enter the ‘number of slopes’ associated with the transmission tower. A grid is generated based on the ‘number of slopes’. Subsequently, another tab page is displayed to the user to obtain information of the panels. In one embodiment, the user may enter the number of ‘extensions’ in the transmission tower.

In one embodiment, the input data is validated upon receiving to detect the presence of errors and subsequently report the errors to the user.

The method also includes generating a parameter table in response to the user selecting a base shape of the transmission tower in step 320. In one embodiment, the parameter table is generated by auto-calculation of values corresponding to the plurality of slopes and the plurality of parameters received from the user.

The method also includes generating a panel information table based on the generated parameter table in step 330.

The method also includes generating a multi-dimensional model of the transmission tower in real-time based on the panel information table along with a plurality of output files in step 340. The output files include information of primary nodes and secondary nodes in the transmission tower. In one embodiment, the output files are displayed in Windows Excel sheets. Further, the output files include sections sheet, angle groups, angle members sheet, body wind area calculations, and panel wise information.

In one embodiment, the multi-dimensional model is created by a ‘slice and dice’ approach that typically creates nodes, members, panels, slopes, and then the tower in succession. In other words, the transmission tower is considered to be an assembly of multiple slopes and each slope is considered to be an assembly of multiple panels and each panel is considered to be an assembly of multiple members and multiple nodes called as a pattern.

The method also includes constructing one or more patterns of the multi-dimensional model of the transmission tower in step 350. The multi-dimensional models are a 2D model and a 3D model. The patterns are stored in a database (also referred to as ‘pattern library’).

The method also includes presenting the multi-dimensional model of the transmission tower along with the one or more patterns to the user in step 360. The one or more patterns are retrieved from a database that stores pre-defined patterns of tower geometry.

The method also includes validating the geometry data and providing tower clearances in step 370.

The method also includes recommending one or more combinations of assembling the transmission tower based on geographical and climatic conditions in step 380. For instance, a load applied on the transmission tower may tend to bend the said. Therefore, to make the transmission tower withstand the load, the base of the transmission tower needs to be strong. Such kind of recommendations may be proposed to the user.

Further, it is to be noted that the method described herein is not limited to ‘transmission towers’ but can also be implemented for any other suitable tower, such as rectangular towers and the like.

Furthermore, the method disclosed herein may also include a feature to check the minimum height of the transmission towers at a specific location. The method may also consider general practices for safeguarding people while generating the tower models.

Various embodiments of the system and method for real-time multi-dimensional modelling of transmission towers as described above allows tower designers to generate the inputs for tower geometry, tower body wind loads and tower weight very fast and effortlessly. Further, the system and method disclosed herein allows tower designers to focus more on tower design and optimization. Furthermore, comparison of multiple tower weights for various geometry configurations can be performed at ease. Moreover, the inputs for PLS-Tower are generated in less that ten minutes.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for developing a multi-dimensional model of a transmission tower comprising:
a processing subsystem hosted on a server, wherein the processing subsystem is configured to execute on a network to control bidirectional communications among a plurality of modules comprising:
an input module operatively coupled with a user interface, wherein the input module is configured to receive input data comprising of a plurality of parameters in succession and a count of a plurality of slopes required to model a transmission tower from a user, wherein the plurality of parameters comprises information of the plurality of slopes, base width and top width of the plurality of slopes and information of a plurality of panels;
a generating module operatively coupled to the input module, wherein the generating module is configured to:
generate a parameter table in response to the user selecting a base shape of the transmission tower, wherein the parameter table is generated by auto-calculation of values corresponding to the plurality of slopes and the plurality of parameters received from the user;
generate a panel information table based on the generated parameter table;
generate a multi-dimensional model of the transmission tower in real-time based on the panel information table along with a plurality of output files;
a pattern generation module operatively coupled to the generating module, wherein the pattern generation module is configured to construct one or more patterns of the multi-dimensional model of the transmission tower, and the one or more patterns are subsequently stored in a database; and
a display module to present the multi-dimensional model of the transmission tower along with the one or more patterns to the user.

2. The system as claimed in claim 1 further comprising:
an optimizing module operatively coupled to the pattern generating module and configured to receive optimization parameters for the generated multi-dimensional model of the transmission tower based on one or more natural factors, wherein the natural factors comprise of wind loads and weight of the plurality of structures.

3. The system as claimed in claim 1 further comprising:
a recommendation module operatively coupled with the pattern generation module and configured to:
validate the geometry data for overloading conditions and subsequently rendering suggestions to withstand the overloading conditions by altering the geometry data; and
recommend one or more combinations of assembling the transmission tower based on geographical and climatic conditions.

4. The system as claimed in claim 1 wherein the input data is validated upon receiving to detect the presence of errors and subsequently report the errors to the user.

5. The system as claimed in claim 1 wherein the one or more patterns of the multi-dimensional model of the transmission tower is stored in a pattern library, wherein the pattern library allows the user to select a desired tower pattern for subsequent modelling process.

6. The system as claimed in claim 1 wherein the plurality of parameters comprises of a plurality of slopes, panels, members, nodes and extensions of the transmission tower in succession.

7. The system as claimed in claim 1 wherein the output files is forwarded to a third-party application.

8. The system as claimed in claim 1 wherein the multi-dimensional model comprises a two-dimensional graphical representation and a three-dimensional graphical representation of the transmission tower, wherein the two-dimensional graphical representation is used for reporting purposes and the three-dimensional graphical representation is used to display a precise interpretation of the transmission tower.

9. A method for developing a multi-dimensional model of transmission towers comprising:
receiving, by an input module, input data comprising of a plurality of parameters in succession and a plurality of slopes required to model a transmission tower from a user, wherein the plurality of parameters comprises information of the plurality of slopes, base width and top width of the plurality of slopes and information of a plurality of panels;
generating, by a generating module, a parameter table in response to the user selecting a base shape of the transmission tower, wherein the parameter table is generated by auto-calculation of values corresponding to the plurality of slopes and the plurality of parameters received from the user;
generating, by the generating module, a panel information table based on the generated parameter table;
generating, by the generating module, a multi-dimensional model of the transmission tower in real-time based on the panel information table along with a plurality of output files;
constructing, by a pattern generation module, one or more patterns of the multi-dimensional model of the transmission tower;
presenting, by a display unit, the multi-dimensional model of the transmission tower along with the one or more patterns to the user;
validating, by a recommendation module, the geometry data for overloading conditions and subsequently rendering suggestions to withstand the overloading conditions by altering the geometry data; and
recommending, by the recommendation module, one or more combinations of assembling the transmission tower based on geographical and climatic conditions.
